(19) United States
(12) Patent Application Publication
(10) Pub. No.: US 2016/0296898 A1
(43) Pub. Date: Oct. 13, 2016

(54) Cleaning System for a Mixing Container

(71) Applicant: NETZSCH-Feinmahltechnik GmbH, Selb (DE)

(72) Inventors: Michael Degel, Kirchenlamitz (DE); Peter Hofmann, Waldershof (DE); Udo Enderle, Arzberg (DE)

(21) Appl. No.: 15/093,050

(22) Filed: Apr. 7, 2016

(30) Foreign Application Priority Data
Apr. 10, 2015 (DE) 202015101761

(51) Int. Cl. B01F 15/00; B05B 1/02; B01F 1/00; B05B 3/10

(52) U.S. Cl. CPC B01F 15/00032; B05B 3/10; B05B 1/02; B01F 1/0011

(57) ABSTRACT

Cleaning system for a mixing vessel with at least one stirring element within a working area including at least one fixed spray device and a movable spraying device, wherein the fixed spray device is arranged and oriented so that their blasting a spray shadow of the movable spray cover.

### TECHNICAL FIELD

The invention relates to a cleaning system for a mixing container with at least one stirring element inside a working chamber.

### BACKGROUND

Mixing is one of the basic operations in mechanical process engineering. At least two starting materials are united in this way to form a new material and are mixed as homogeneously as possible. Although mixing represents a basic operation, it is nonetheless, in terms of process engineering, essentially a part of a whole process-engineering system. In all areas of process engineering, therefore, stirring elements are used for the mixing of materials, on the laboratory scale and up to orders of magnitude of 15 m³ and over.

The stirring elements are adapted to the given basic operation and of the given material system and convert mechanical energy into kinetic energy. The various basic operations can be traced back to homogenising, suspending, dispersing, gassing and the intensifying of a heat exchanger. The stirring element can be disposed concentrically or eccentrically in the mixing container. The mixing container and possibly a mixing container cover form the working chamber.

Mixing processes are optimised by a rapid exchange of products in practice. The focus is therefore on cost-effective and yet efficient cleaning, particularly on account of high hygiene demands. The cleaning process can be optimised by the use of a suitable cleaning system directly on the mixing container. It is known to clean mixing containers and stirring elements with high-pressure cleaners or a water hose. However, this kind of cleaning is not very efficient and is time-consuming. Use is thus also made of cleaning systems which are provided with a mobile spraying device. The spraying device is retracted and extended for example on a telescopic arm and the mixing container and the stirring element are thus cleaned. The cleaning is intended to be improved by additional swivelling of the entire telescopic arm. Such cleaning devices are also referred to as cleaning lances.

A device for the automated wet cleaning and drying of production and storage containers is known for example from DE 10 2009 059 252 A1, wherein at least one cleaning opening is introduced in a container wall and a cleaning device constituted as a cleaning lance provided with a drive can be moved into a product chamber and out again. A closure plug is disposed on the container-side end of the installation housing in such a way that it opens a product chamber when the cleaning lance is extended and closes the product chamber again without any dead space when the cleaning lance is retracted. The term production or storage container is intended to include all production and storage devices which have a production chamber and a container wall that are to be cleaned, and including in particular mixers, kneaders and stirrers, for example.

Devices such as mixers, kneaders and stirrers, however, usually comprise a stirring element, which is disposed inside the product chamber and is intended to enable efficient mixing of the initial materials. The stirring element can prevent efficient and thorough cleaning or at least make it difficult. Depending on the positioning of the cleaning lance, a so-called spray shadow can arise with a shadow space inside which no cleaning effect or only a slight cleaning effect can be achieved with the cleaning jets of the cleaning lance.

To overcome this problem, the cleaning lance could for example be disposed in a swivelling manner with respect to the container. Such an arrangement is known from patent DE 2121128. A mobile high-pressure spraying device with a telescopic part for a rapid and efficient introduction of the device into the tank is proposed for cleaning a storage or working tank. The spraying device is fixed to the tank in a swivelling manner by means of a spherical housing.

It would however be desirable to make available a cleaning system which enables cleaning also in the spray shadow, inside a spray shadow space. A complicated bearing of the cleaning device to enable swivelling of the latter during cleaning so as to prevent or minimise a spray shadow would emerge. The known cleaning systems of the aforementioned type, however, are inadequate for this purpose.

The problem underlying the invention, therefore, is to provide a cleaning system which enables efficient cleaning of a mixing container in which a stirring element is disposed.

### SUMMARY

According to the invention, this problem is solved by the fact that the cleaning system comprises at least one stationary and one mobile spraying device, wherein the stationary spraying device is disposed and orientated in such a way that, during a cleaning process, its cleaning jets cover a spray shadow of the mobile spraying device.

The invention proceeds from the consideration that, in order to achieve efficient cleaning, an additional swivelling motion of the mobile spraying device in the mixing container is not necessarily required.

Mobile spraying device is understood to mean a cleaning lance or for example a generic spraying device, the spray head whereof is moved along an axis inside the mixing container during a cleaning process. For this purpose, the spraying device can be mounted for example fixedly on the mixing container or a cover and its spray head is moved, for example during cleaning, via an opening in the cover into the mixing container and is then moved out again. Depending on the degree of soiling, the cleaning process can be repeated once or several times.

Due to the fact that a stirring element is disposed in the cleaning container, the cleaning jets of the spray head directed onto the stirring element do not reach the surface of the container wall lying opposite in this direction and a spray shadow arises, as a result of which areas or parts of the stirring element located in the spray shadow are also not cleaned or only insufficiently. Stirring element within the meaning of the invention is understood to mean stirring elements disposed in the working chamber as well as drive elements, in particular a drive or stirrer shaft.

In order that a sought cleaning effect can also be achieved in the spray shadow, at least one further stationary spraying device is additionally disposed and orientated in such a way that, during the cleaning process in the mixing container, areas of the mixing container and the stirring element lying in the spray shadow of the mobile spraying device are also reached by cleaning jets of the stationary spraying device.

The stationary spraying device is preferably assigned to a mixing container cover. The advantage over a spraying device assigned to the mixing container is to be seen in the fact that the cleaning can take place for a plurality of mixing containers with only one cover, irrespective of the cleaning system. For this purpose, the mixing container cover can be fastened to the mixing container by means of one or more screw connections. The invention is of course not limited to such a fastening. For example, the cover can be connected to the mixing container in a firmly bonded manner, by welding, soldering or suchlike.

In a preferred development, the stationary spraying device or the spray head is disposed and orientated on the cover in such a way that its cleaning jets can enter into the working chamber through an opening in the mixing container cover. The stationary spraying device is thus outside the mixing container, in contrast with an arrangement inside the mixing container, protected against soiling to an extent such that only product or starting material passing through the opening can lead to soiling of the stationary spraying element. This protection can be improved still further in that the opening in the cover, such as is provided in DE 10 2009 059 252 A1 for the opening for the cleaning lance, is constituted closable, so that the opening is closed, manually operated or automatically, especially during a mixing process.

The stationary spraying device or its spray head is particularly preferably constituted adjustable. The effect of this is that the spraying process can be adapted to the given preceding mixing task and the stirring element used. In particular, the cleaning jets can be orientated by the adjustment in such a way that efficient cleaning is possible.

At least one spraying device of the cleaning system is preferably provided with a self-rotating spray head. Due to the fact that the mobile cleaning device, in particular a cleaning lance, is equipped with a self-rotating spray head generating 360° fanning-out of the cleaning jets, the emerging spray shadow can be minimised. In a similar manner thereto, the stationary spraying device can be provided additionally or alone with a self-rotating spray head, with the aim of increasing or extending the cleaning effect and/or the cleaning area of the stationary spraying device.

In a further variant, the stationary and the mobile spraying device are coupled by means of a control device. The two spraying devices can thus be coordinated with one another and controlled according to the cleaning task. For example, different cleaning programs can be stored and retrieved in a data memory by means of the control device.

According to a preferred development, an angle of inclination of the mobile spraying device can be fixedly adjustable. Depending on the use of specific mixing containers and/or stirring elements, an adjustment of the angle of inclination, i.e. the angle at which the mobile spraying device enters into the mixing container, may be necessary. The angle of inclination can thus be adjusted in such a way that, on the one hand, efficient cleaning can take place and, on the other hand, the mobile spraying device does not collide with the stirring element during the cleaning process.

In a particularly advantageous embodiment, the stationary spraying device is provided with a protection device. The protection of the spraying device against soiling can, as already described above, be achieved by its arrangement outside the mixing container and a closable opening assigned to the spraying device. Protection can however also take place by means of a protection device which generates an air flow directly in front of the opening, which is intended to prevent product or starting material from getting to the spray head during the mixing process.

The advantages achieved with the invention lie in particular in the fact that an occurring spray shadow, which may be caused by a stirring element, is prevented or at least reduced. Existing cleaning systems can be modified and improved by fitting the additional stationary spraying device. For this purpose, it is merely necessary, for example, for a cover of the mixing container to be provided with the stationary spraying device, at the point provided for this according to the invention.

### BRIEF DESCRIPTION OF THE DRAWINGS

An example of embodiment of the invention is explained in greater detail with the aid of diagrammatic drawings. In the figures:

FIG. 1 shows a dissolver known from the prior art with a mixing container and a mobile spraying device.

FIG. 2 shows a dissolver without the represented mixing container, with a cleaning system comprising a mobile and a stationary spraying device.

FIG. 3 shows a cover of a dissolver with a mounted shaft bearing for a stirring element and a cleaning system with a mobile and a stationary spraying device.

FIG. 4 shows a cleaning area produced by a mobile spraying device, with the formation of a spray shadow.

### DETAILED DESCRIPTION

Identical parts are provided with the same reference numbers in all the figures.

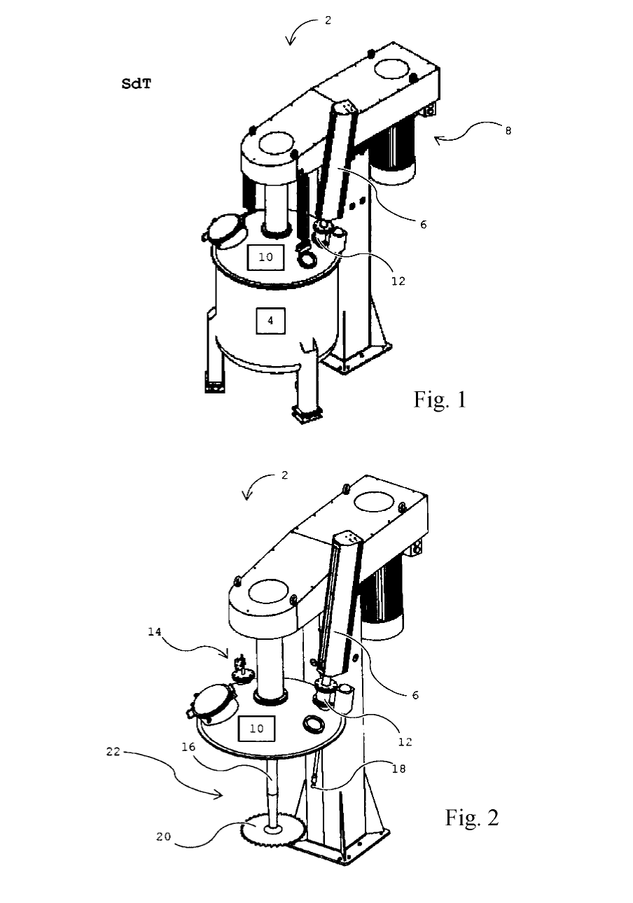

A dissolver 2 known from the prior art with a mixing container 4 and a mobile spraying device 6 is represented in FIG. 1. Dissolvers 2 are used for mixing or dispersing solids in liquids. The mixing process takes place in a mixing container 4. A stirring element 22 is disposed in mixing container 4 and is driven by means of a drive unit 8 via at a stirrer shaft 16, which is provided at the end, in the working chamber of mixing container 4, with a dispersing disc 20. A cover 10 is assigned to mixing container 4, said cover comprising a mounting flange 12 for mobile spraying device 6 constituted as a cleaning lance 6. A spray head 18 of cleaning lance 6, which is inclined with respect to mixing container 4, can be fed via a mounting flange 12 and an opening in the cover to mixing container 4 for a cleaning process.

A dissolver 4 of the same design is shown in FIG. 2, but without represented mixing container 4. Dissolver 2 comprises a cleaning system, comprising a stationary spraying device 14 and a cleaning lance 6 as a mobile spraying device, wherein stationary spraying device 14 is disposed and orientated on cover 10 in such a way that its cleaning jets cover a spray shadow 30 arising during the cleaning process. The spray shadow arises in this embodiment essentially due to a stirrer shaft 16, which is disposed during cleaning between spray head 18 of cleaning lance 6 and a surface 34 of mixing container wall 4 lying opposite in the direction of stirrer shaft 16. In this direction, the cleaning jets strike in part only stirrer shaft 16.

As result of the fact that cleaning lance 6 is inclined, the cleaning shadow is moved in the clockwise direction when spray head 18 is introduced into the mixing container. The inclination of cleaning lance 6 also enables cleaning of the underside side of dispersing disc 20, in that stirring element 22 is raised by means of an integrated lifting and lowering device. Spray head 18 can thus pass dispersing disc 20 and also clean the latter at the underside.

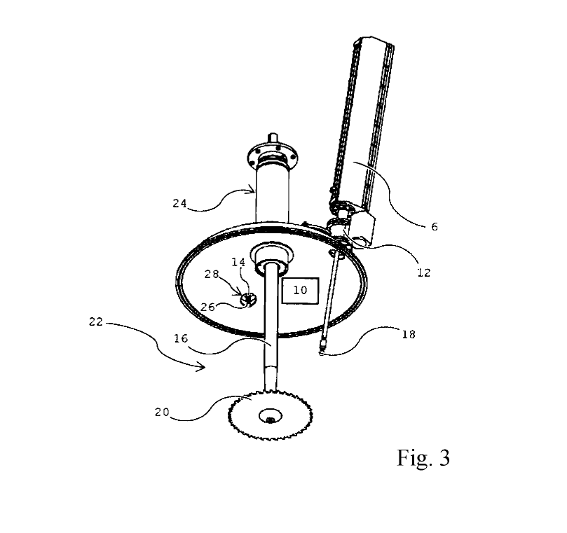

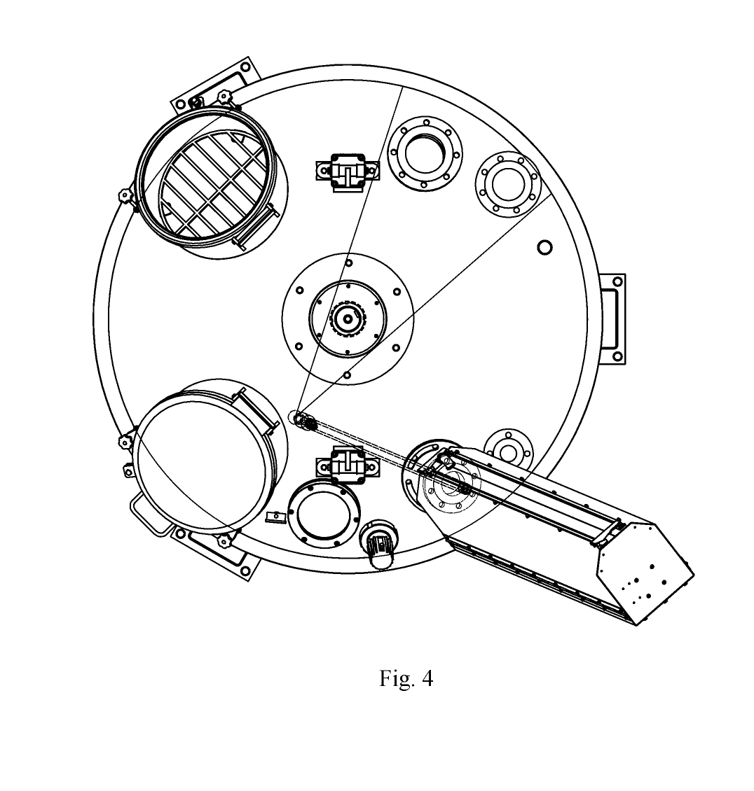

For effective covering of spray shadow 30 by stationary spraying device 14, the latter is disposed centrally, related to the container radius and circumference, over the entire area in cross-section affected by spray shadow 30. Such an arrangement on a cover 10 of a mixing container 4, viewed in the radial direction, is illustrated in FIG. 3. The latter shows components of a dissolver 2, i.e. a shaft bearing 24 mounted on cover 10 for a stirrer shaft 16 with a dispersing disc 20 and a cleaning system, comprising cleaning lance 6 and stationary spraying device 14.

Stationary spraying device 14, as also shown in FIG. 4, is mounted on cover 10 by means of a flange connection 24 and its spray head 18 projects via an opening 28 in cover 10 into mixing container 4. Spray head 26, in particular the nozzles of spray head 26, are orientated in such a way that a cleaning jet essentially strikes the surface of container wall 24 and cleaning element 22 in spray shadow 30 and cleans said surface.

FIG. 4 shows a mixing container 4 with a cover 10 viewed from above. As also shown in the representations of FIG. 1 to FIG. 3, shown cleaning lance 6 is disposed, relative to the rotor axis of stirring element 22, inclined around the two other spatial axes on cover 10 for mixing container 4. For design reasons, it is not always possible to dispose stationary spraying device 14 centrally in the radial direction. By means of a suitable orientation of spray head 26, the displacement towards the edge of the container can largely be compensated for. As a result of this and of the arrangement of stationary spraying device 14 by means of a fixing flange 24 inside a spray shadow 30, a cleaning area 32 of cleaning lance 6 represented shaded is extended.

Spray head 18 of cleaning lance 6 generates a spherical 360° spraying pattern. This enables, as also shown in FIG. 4, a fan-shaped spraying pattern, as a result of which spray shadow 30, proceeding from stirrer shaft 16, is also enlarged fan-shaped towards the edge of the container. Represented spraying area 32 corresponds to a plane running centrally through spray head 18, which is located precisely, viewed in the axial direction of stirrer shaft 16, in roughly the centre of mixing container 4.

The cleaning system is specifically designed for efficient cleaning of a mixing container 4 with a stirring element 22 and at least one mobile spraying device 6, where a disadvantageous spray shadow 30 arises on account of stirring element 22 during a cleaning process. As a result of the arrangement of the at least one further stationary spraying device according to the invention, it has become possible also for areas of the surface in mixing container 4 and stirring element 22 in spray shadow area 30 to be subjected to cleaning jets.

1. A cleaning system for a mixing container with at least one stirring element inside a working chamber, comprising at least one stationary spraying device, and a mobile spraying device, wherein the stationary spraying device is disposed and orientated into such a way that its cleaning jets cover a spray shadow of the mobile spraying device.

2. The cleaning system according to claim 1, wherein the stationary spraying device is assigned to a mixing container cover.

3. The cleaning system according to claim 2, wherein the cleaning jets of the stationary spraying device enter into the working chamber through an opening in the mixing container cover.

4. The cleaning system according to claim 1, wherein the stationary spraying device is adjustable.

5. The cleaning system according to claim 1, wherein the at least one spraying device is provided with a self-rotating spray head.

6. The cleaning system according to claim 1, wherein the stationary spraying device and the mobile spraying device are coupled by means of a control device.

7. The cleaning system according to claim 1, with an adjustable spraying device, the angle of inclination whereof is adjustable.

8. The cleaning system according to claim 1, with a stationary spraying device, which is provided with a protection device.

9. A dissolver with a cleaning system for a mixing container with at least one stirring element inside a working chamber, comprising at least one stationary spraying device and a mobile spraying device, wherein the stationary spraying device is disposed and orientated into such a way that its cleaning jets cover a spray shadow of the mobile spraying device.

10. The dissolver of claim 9, wherein the stationary spraying device is assigned to a mixing container cover.

11. The dissolver of claim 9, wherein the stationary spraying device is adjustable.

12. The cleaning system according to claim 2, wherein the stationary spraying device is adjustable.

13. The cleaning system according to claim 2, wherein the at least one spraying device is provided with a self-rotating spray head.

14. The cleaning system according to claim 4, wherein the at least one spraying device is provided with a self-rotating spray head.

15. The cleaning system according to claim 2, wherein the stationary spraying device and the mobile spraying device are coupled by means of a control device.

16. The cleaning system according to claim 4, wherein the stationary spraying device and the mobile spraying device are coupled by means of a control device.

17. The cleaning system according to claim 2, with an adjustable spraying device, the angle of inclination whereof is adjustable.

18. The cleaning system according to claim 4, with an adjustable spraying device, the angle of inclination whereof is adjustable.
